(19) United States
(12) Patent Application Publication
(10) Pub. No.: US 2006/0221031 A1
(43) Pub. Date: Oct. 5, 2006

(54) Display panel and display device having the same

(76) Inventors: Hak-Sun Chang, Yongin-si (KR); Chang-Hun Lee, Yongin-si (KR); So-Youn Park, Suwon-si (KR)

Correspondence Address: CANTOR COLBURN, LLP, 55 GRIFFIN ROAD SOUTH, BLOOMFIELD, CT, 06002, US

(21) Appl. No.: 11/262,065

(22) Filed: Oct. 28, 2005

(30) Foreign Application Priority Data
Apr. 1, 2005 (KR) 2005-27638

(51) Int. Cl. G09G 3/36

(52) U.S. Cl. 345/89

(57) ABSTRACT

A display panel includes a first substrate, a second substrate and a liquid crystal layer. The second substrate faces the first substrate. The second substrate includes a switching device that is electrically connected to a data line and a gate line, a pixel electrode that is electrically connected to the switching device, and an interference-reducing member that reduces electrical interference between the data line and the pixel electrode. The liquid crystal layer is disposed between the first and second substrates, with the liquid crystal layer being operated in an optical compensated bend (OCB) mode. Therefore, an electric interference between the data line and the pixel electrode is prevented and the bend alignment state is stably maintained. Additionally, a manufacturing cost is lowered.

This application claims priority to Korean Patent Application No. 2005-27638, filed on Apr. 1, 2005 and all the benefits accruing therefrom under 35 U.S.C. §119, and the contents of which in its entirety are herein incorporated by reference in its entirety.

### BACKGROUND OF THE INVENTION

1. Field of the Invention

The present invention relates to a display panel and a display device having the display panel. More particularly, the present invention relates to a display panel capable of reducing manufacturing costs thereof, enhancing manufacturing efficiency and enhancing a display quality, and a display device having the display panel.

2. Description of the Related Art

Recently, a liquid crystal display (LCD) device has been employing an optical compensated bend (OCB) mode in order to widen a viewing angle and enhance liquid crystal response speed. The liquid crystal of a liquid crystal cell of the OCB mode LCD device is in a homogenous state. When electric fields are applied to the liquid crystal of LCD device, the liquid crystal is changed to a bend state through transient splay and asymmetric splay.

In order to obtain the bend state in the liquid crystal, a specific voltage should be applied for a specific time. When the liquid crystal is in the bend state, the liquid crystal response speed is enhanced and a viewing angle becomes widened.

The liquid crystal is in the bend state when a dielectric anisotropy Δε is substantially equal to or more than about 10, and a pre-tilt angle is in a range of about 8 degrees to 10 degrees. Traditionally, a pixel electrode is formed to cover a storage common electrode in order that the liquid crystal maintains the bend state.

The LCD panel of the OCB mode requires a complex manufacturing process which results in a high manufacturing cost. Furthermore, a distance between a data line and a pixel electrode is relatively short, which induces electrical coupling and as a result a display quality of the LCD panel is lowered.

### BRIEF SUMMARY OF THE INVENTION

The present invention provides a display panel capable of reducing a manufacturing cost thereof and enhancing a display quality.

The present invention also provides a display apparatus having the display panel.

In an exemplary display panel according to the present invention, the display panel includes a first substrate, a second substrate and a liquid crystal layer. The second substrate faces the first substrate. The second substrate includes a switching device that is electrically connected to a data line and a gate line, a pixel electrode that is electrically connected to the switching device, an interference-reducing member that reduces electrical interference between the data line and the pixel electrode. The liquid crystal layer is disposed between the first and second substrates, with the liquid crystal layer being operated in an optical compensated bend (OCB) mode.

In an exemplary display apparatus according to the present invention, the display apparatus includes a display panel and a driving part. The display panel includes a first substrate, a second substrate and a liquid crystal layer. The second substrate faces the first substrate and includes an interference-reducing member that reduces electrical interference between a data line and a pixel electrode. The liquid crystal layer is disposed between the first and second substrates. The liquid crystal layer is operated in an optical compensated bend (OCB) mode. The driving part applies a gray scale voltage corresponding to an image during a first period of a frame, and a gray scale voltage corresponding to a non-image during a second period of the frame to the display panel.

In another exemplary display apparatus according to the present invention, the display apparatus includes a display panel and a driving part. The display panel includes a liquid crystal layer having a dielectric anisotropy in a range of about 5 to about 10, a first alignment layer facing a first side of the liquid crystal layer, a second alignment layer facing a second side of the liquid crystal layer, and an interference-reducing member that reduces an electric interference between a data line and a pixel electrode. The driving part applies a gray scale voltage corresponding to an image during a first period of a frame, and a gray scale voltage corresponding to a non-image during a second period of the frame to the display panel.

Therefore, an electric interference between the data line and the pixel electrode is prevented and the bend alignment state is stably maintained. Additionally, a manufacturing cost is lowered.

### BRIEF DESCRIPTION OF THE DRAWINGS

The above and other features and advantages of the present invention will become more apparent by describing in detailed exemplary embodiments thereof with reference to the accompanying drawings, in which:

FIG. 1 is a layout illustrating an exemplary embodiment of a display panel of an OCB mode according to the present invention;

FIG. 2 is a cross-sectional view taken along line I-I′ in FIG. 1;

FIG. 3 is a conceptual view illustrating a pre-tilt angle of an alignment layer in FIG. 2;

FIG. 4 is an OCB mode VT curve illustrating a relation between a voltage applied to a liquid crystal layer in FIG. 2 and an optical transmittance of the liquid crystal layer in FIG. 2;

FIG. 5 is a layout illustrating another exemplary embodiment of a display panel of an OCB mode according to the present invention;

FIG. 6 is a cross-sectional view taken along line II-II′ in FIG. 5;

FIG. 7 is a block diagram illustrating an exemplary embodiment of a display apparatus according to the present invention;

FIG. 8 is a block diagram illustrating a timing control section in FIG. 7;

FIG. 9A is a timing diagram illustrating a conventional driving method;

FIGS. 9B to 9E are timing diagrams illustrating various impulsive driving methods according to the present invention; and

FIG. 10 is a graph displaying VT curves corresponding to each impulse driving method in FIGS. 9A to 9E.

### DETAILED DESCRIPTION OF THE INVENTION

It should be understood that the exemplary embodiments of the present invention described below may be varied and modified in many different ways without departing from the inventive principles disclosed herein, and the scope of the present invention is therefore not limited to these particular flowing exemplary embodiments. Rather, these embodiments are provided so that this disclosure will be thorough and complete, and will fully convey the concept of the invention to those skilled in the art by way of example and not of limitation.

Hereinafter, the exemplary embodiments of the present invention will be described in detail with reference to the accompanied drawings. It is noted that various changes, substitutions and alterations can be made herein without departing from the spirit and scope of the invention as defined by the exemplary embodiments that will be described below. The exemplary embodiments are only examples for showing the spirit of the present invention to a person skilled in the art. In the figures, the thickness of layers is exaggerated in order to show clarity. The term “disposed on” means “disposed over”. In other words, something may be disposed therebetween. The term “disposed directly on” means that nothing is disposed therebetween.

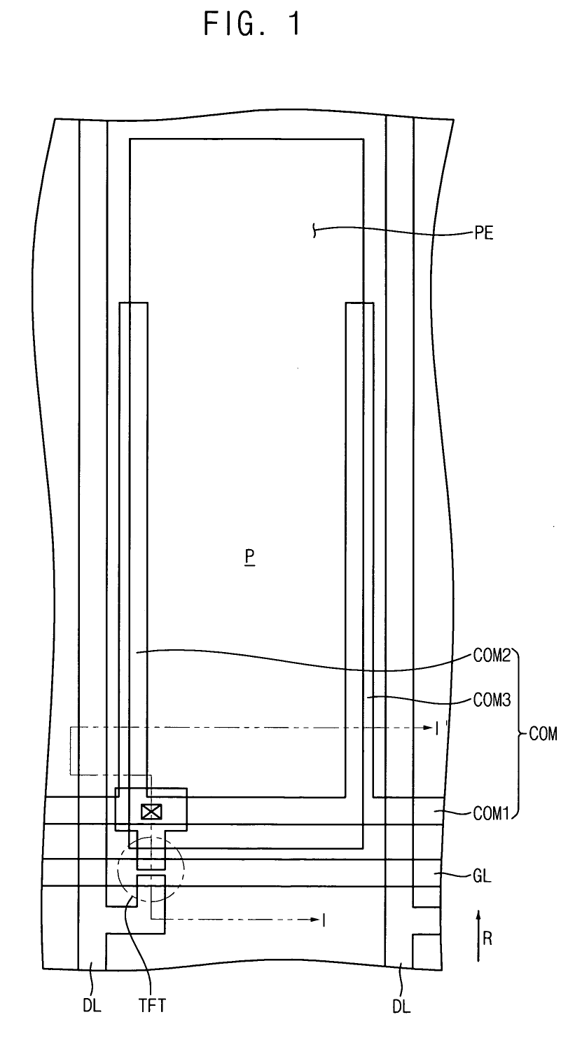

FIG. 1 is a layout illustrating an exemplary embodiment of a display panel of an OCB mode according to the present invention.

Referring to FIG. 1, a display panel includes a pixel portion ‘P’. The pixel portion ‘P’ includes a switching device TFT, a pixel electrode PE and a storage capacitor Cst (not shown). The switching device TFT may be adjacent to a gate line GL and a data line DL. The switching device TFT includes a gate electrode, a drain electrode and a source electrode. The gate electrode of the switching device TFT corresponds to the gate line GL. In other words, the gate line GL is electrically connected to the gate electrode. Likewise, the source electrode is electrically connected to the data line DL and the drain electrode is electrically connected to the pixel electrode PE.

When a gate signal is applied to the gate line GL, the switching device TFT is turned on. When the switching device TFT is turned on a data voltage applied to the data line DL is applied to the pixel electrode PE through the switching device TFT.

The storage capacitor Cst includes a common wiring COM and the pixel electrode PE. In other words, the common wiring COM and the pixel electrode PE define the storage capacitor Cst. The common wiring COM includes a first common line COM1, a second common line COM2 and a third common line COM3. The first common line COM1 is electrically connected to the common wiring COM of an adjacent pixel portion ‘P’. The second and third common lines COM2 and COM3 extend from the first common line COM1, such that the second and third common lines COM2 and COM3 are substantially parallel with the data line DL. The second and third common lines COM2 and COM3 are spaced apart from each other. A portion of the second common line COM2 may be overlapped with a first side of the pixel electrode PE, and a portion of the third common line COM3 may be overlapped with a second side of the pixel electrode PE.

In an exemplary embodiment, a liquid crystal capacitor is defined by the pixel electrode PE, a common electrode formed at a color filter substrate and a liquid crystal layer disposed between the pixel electrode PE and the common electrode. When the data voltage is applied to the pixel electrode PE through the switching device TFT, electric fields are generated between the pixel electrode PE and the common electrode. When an electrical interference between a voltage of the pixel electrode PE and the data voltage of the data line DL is generated, the display quality is lowered.

Accordingly, to prevent the electrical interference between the pixel electrode PE and the data line DL, the pixel electrode PE covers portions of the second and third common lines COM2 and COM3. Therefore, by reducing the electrical interference between the pixel electrode PE and the data line DL the display quality is enhanced.

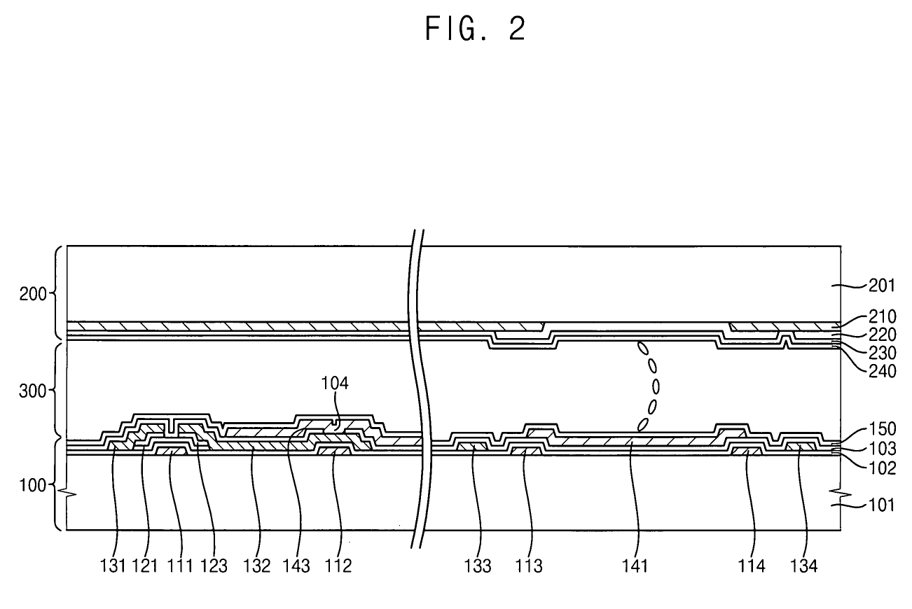

FIG. 2 is a cross-sectional view taken along line I-I′ in FIG. 1.

Referring to FIGS. 1 and 2, the display panel includes an array substrate 100, a color filter substrate 200 and a liquid crystal layer 300 disposed between the array substrate 100 and the color filter substrate 200. The array substrate 100 includes a first base substrate 101.

The first base substrate 101 may be made of any suitable optically transparent material. A gate metal pattern is formed on the first base substrate 101. The gate metal pattern includes the gate electrode 111 (GL in FIG. 1) of the switching device TFT, a first common line 112 (COM1 in FIG. 1), a second common line 113 (COM2 in FIG. 1) and a third common line 114 (COM3 in FIG. 1).

A gate insulation layer 102 is formed on the first base substrate 101 having the gate metal patterns formed thereon. The gate insulation layer 102 may be made of any suitable a dielectric material including, but not limited to, silicon nitride, silicon oxide, etc. In a particular exemplary embodiment, the gate insulation layer 102 has a thickness of about 4500 angstroms. However, it is also contemplated that the thickness of the insulation layer 102 may vary significantly.

A semiconductor layer is formed on the gate insulation layer 102. The semiconductor layer includes an activation layer 121 formed on the gate insulation layer 102, and an ohmic contact layer 123 formed on the activation layer 121. The activation layer 121 may be made of material including amorphous silicon, and the ohmic contact layer 123 may be made of material including n+ amorphous silicon. The semiconductor layer may be formed adjacent to the gate electrode 111 of the switching device TFT.

A metal layer is formed over the first base substrate 101 having the semiconductor layer formed thereon. The metal layer is patterned to form a data metal pattern including a source electrode 131, a drain electrode 132 of the switching device TFT, and data lines 133 and 134 (DL in FIG. 1). The data lines 133 and 134 may be adjacent to the second and third common lines 113 and 114.

A passivation layer 103 is formed over the first base substrate 101 having the data metal pattern formed thereon. In a particular exemplary embodiment, the passivation layer 103 has a thickness substantially equal to or less than about 4000 angstroms. The passivation layer 103 includes a contact hole 104 that exposes a portion of the drain electrode 132. In an exemplary embodiment, the passivation layer 103 may be made of any suitable inorganic material. Alternatively, the passivation layer 103 may be made of a suitable organic material or both an organic and inorganic material.

An optically transparent and electrically conductive layer may be made of materials including, but not limited to, indium tin oxide (ITO), indium zinc oxide (IZO), etc. The optically transparent and electrically conductive layer is formed over the first base substrate 101 having the passivation layer 103 formed thereon. The optically transparent and electrically conductive layer is patterned to form a pixel electrode pattern. The pixel electrode pattern includes the pixel electrode 141 (PE in FIG. 1), and a contact portion 143 that electrically connects the pixel electrode 141 to the switching device TFT.

The pixel electrode 141 may cover a portion of the first and second common lines 113 and 114 (hereinafter referred to as a “partial corn structure”), and the overlapping region is defined as a storage capacitor. The pixel portion P except for the overlapping region prevents electrical interference between the pixel electrode 141 and the data lines 133 and 134.

When the display panel employs the “partial corn structure”, a bend alignment margin is reduced. In order to solve the above-mentioned problem, an impulsive driving method is employed. The impulsive driving method includes interposing a black frame between frames.

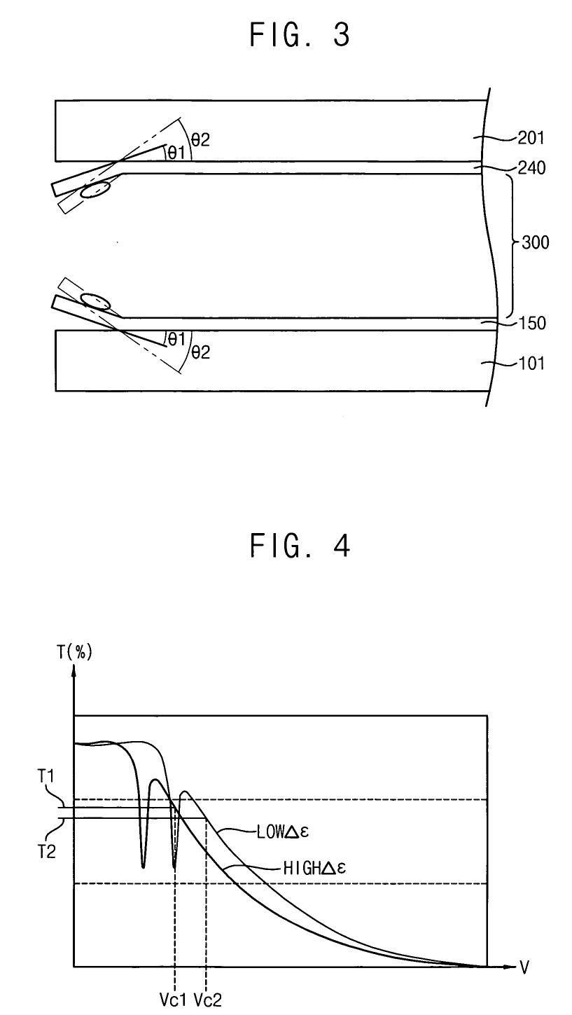

A first alignment layer 150 is formed over the first base substrate 101 having the pixel electrode pattern formed thereon. The first alignment layer 150 has a first rubbing direction ‘R’ and a pre-tilt angle is in a range of about 2 degrees to about 5 degrees. The pre-tilt angle is explained in more detail with reference to FIG. 3.

Continuing with reference to FIG. 2, the color filter substrate 200 includes a second base substrate 201, a light blocking pattern 210, a color filter pattern 220, a common electrode layer 230 and a second alignment layer 240. The second base substrate 201 may be made of any suitable optically transparent material. The light blocking pattern 210 is formed on the second base substrate 201 and includes a plurality of openings, which may be arranged in a matrix shape. The color filter pattern 220 includes a red color filter, a green color filter and a blue color filter. Each of the red, green and blue color filters are disposed on portions of the second base substrate 201 that are exposed through the openings of the light blocking pattern 210.

The common electrode layer 230 is formed on the second base substrate 201 having the light blocking pattern 210 and the color filter pattern 220 formed thereon. The color filter substrate 200 may include a leveling layer that is disposed between the common electrode layer 230, and the light blocking and color filter patterns 210 and 220. The leveling layer levels a surface of the light blocking and color filter patterns 210 and 220.

The second alignment layer 240 is formed on the common electrode layer 230. The second alignment layer 240 has the rubbing direction ‘R’ and a pre-tilt angle in a range of about 2 degrees to about 5 degrees. In an exemplary embodiment, the first and second alignment layers 150 and 240 have the same rubbing direction, and the pre-tilt angles of the first and second alignment layers 150 and 240 are the approximately the same.

FIG. 3 is a conceptual view illustrating a pre-tilt angle of an alignment layer in FIG. 2.

Referring to FIG. 3, a liquid crystal molecule of a conventional OCB mode has a second pre-tilt angle θ2, and a liquid crystal molecule includes a first pre-tilt angle θ1 that is smaller than the second pre-tilt angle θ2.

When the pre-tilt angle increases, a change of angle of liquid crystal molecules becomes reduced, which deteriorates display quality. Therefore in an exemplary embodiment, the display panel adopts the first pre-tilt angle θ1 that corresponds to a pre-tilt angle of a conventional twisted nematic (TN) mode LCD panel to enhance a display quality. In addition to enhancing the display quality adopting the first pre-tilt angle θ1 may cause an increase in a manufacturing efficiency and to lower manufacturing costs. In an exemplary embodiment, the first pre-tilt angle θ1 is in a range of about 2 degrees to about 5 degrees. In order to solve the bend alignment margin induced by decreasing of the pre-tilt angle, the impulsive driving method is employed. As described above the impulsive driving method includes interposing a black frame between frames.

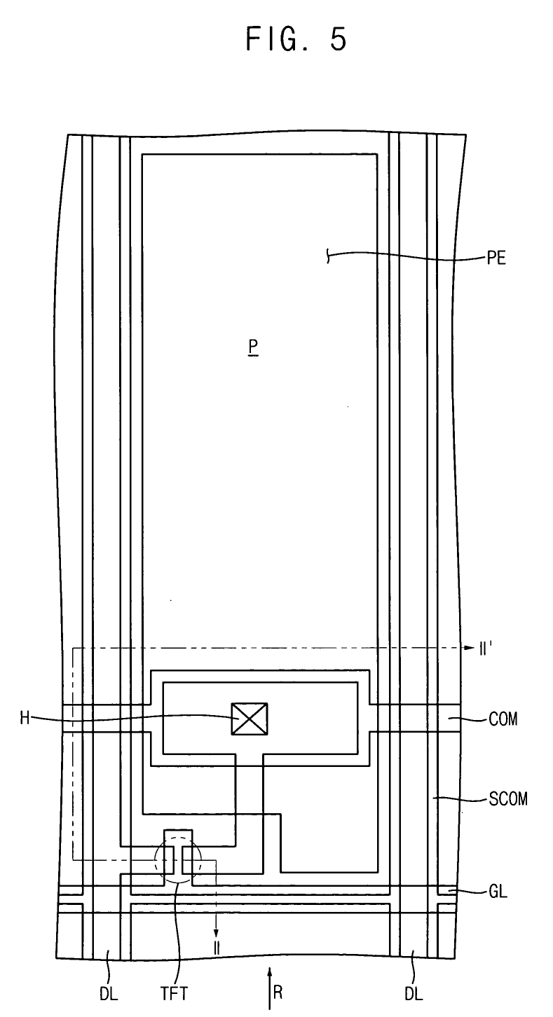

FIG. 4 is an OCB mode VT curve illustrating a relation between a voltage applied to a liquid crystal layer in FIG. 2 and an optical transmittance of the liquid crystal layer in FIG. 2.

Referring to FIG. 4, when a dielectric anisotropy Δε decreases (HIGHΔε→LOWΔε), a critical voltage of OCB mode increases. In general, when the dielectric anisotropy Δε is relatively small, a VT curve becomes flat and a display quality is enhanced in a gray scale level corresponding to a black color.

However, when the dielectric anisotropy Δε decreases (HIGHΔε→LOWΔε), the bend alignment margin also decreases, which raises a critical voltage (Vc1→Vc2) and lowers a optical transmittance (T1→T2).

In an exemplary embodiment, the first and second alignment layers 150 and 240 employ a low pre-tilt angle in order to enhance manufacturing efficiency and reduce manufacturing cost. Additionally the impulsive driving method is employed to solve the problems such as decreasing of the bend alignment margin, rising of the critical voltage and lowering of the transmittance.

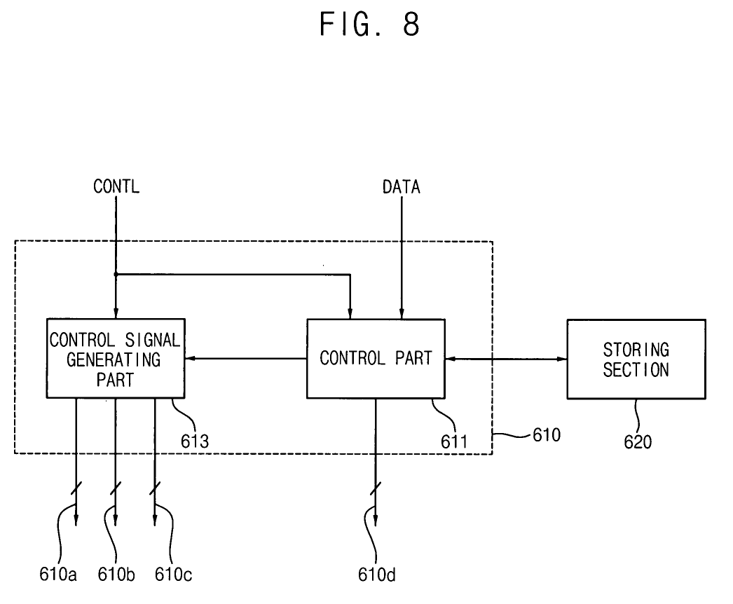

According to the impulsive driving method, a normal frame corresponding to an image and a black frame corresponding to black image alternate with each other causing an unstable bend alignment induced by the relatively low pre-tilt angle to becomes stable. Additionally, rising of the critical voltage Vc is prevented by the impulse driving method. The impulse driving method will be explained in more detail with reference to FIGS. 7 to 10.

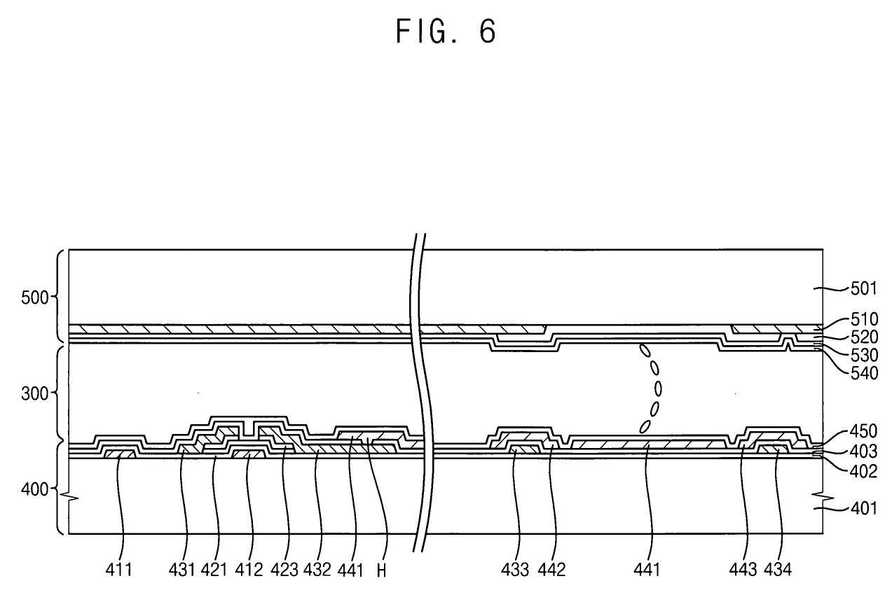

FIG. 5 is a layout illustrating another exemplary embodiment of a display panel of an OCB mode according to the present invention.

Referring to FIG. 5, a display panel of OCB mode includes a pixel portion ‘P’. The pixel portion ‘P’ includes a switching device TFT, a pixel electrode PE, a storage capacitor Cst (not shown) and a shielding common electrode SCOM. The switching device TFT includes a gate electrode that is electrically connected to a gate line GL, a source electrode that is electrically connected to a data line DL, and a drain electrode that is electrically connected to a pixel electrode PE. The gate electrode may protrude from the gate line GL.

The storage capacitor Cst includes a common wiring COM and the pixel electrode PE. In other words, the common wiring COM corresponds to a first electrode of the storage capacitor Cst, and the pixel electrode PE corresponds to a second electrode of the storage capacitor Cst.

A liquid crystal capacitor is defined by the pixel electrode PE, a common electrode (not shown) formed at a color filter substrate (not shown) and a liquid crystal layer disposed between the pixel electrode PE and the common electrode.

The shielding common electrode SCOM and the pixel electrode PE may be formed from a same layer. The shielding common electrode SCOM may be adjacent to the pixel electrode PE. The shielding common electrode SCOM electrically shields the pixel electrode PE from the data line DL to reduce electrical interference between the pixel electrode PE and the data line DL. By shielding the pixel electrode PE from the data line DL display quality is enhanced.

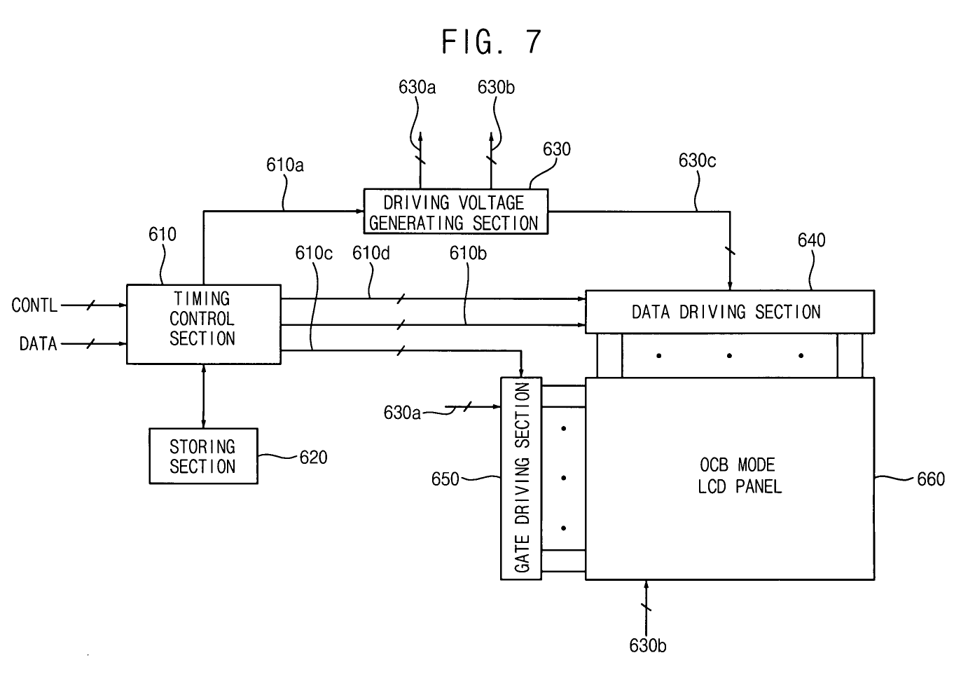

FIG. 6 is a cross-sectional view taken along line II-II′ in FIG. 5.

Referring to FIGS. 5 and 6, the display panel of the OCB mode includes an array substrate 400, a color filter substrate 500 and a liquid crystal layer 300 disposed between the array substrate 400 and the color filter substrate 500.

The array substrate 400 includes a first base substrate 401. A metal layer (not shown) is formed on the first base substrate 401 and the metal layer is patterned to form a gate metal pattern. The gate metal pattern includes a gate electrode 411 (GL in FIG. 5) of the switching device TFT and a common wiring COM of the storage capacitor.

A gate insulation layer 402 is formed on the first base substrate 401 having the gate metal pattern formed thereon. The gate insulation layer 402 may be made of a dielectric material, including but not limited to, silicon nitride, silicon oxide, etc. In an exemplary embodiment, the gate insulation layer 402 has a thickness of about 4500 angstroms. However, it is also contemplated that the thickness of the gate insulation layer 402 may vary significantly.

A semiconductor layer is formed on the gate insulation layer 402. The semiconductor layer includes an activation layer 421 formed on the gate insulation layer 402, and an ohmic contact layer 423 formed on the activation layer 421. The activation layer 421 may be made of material including amorphous silicon, and the ohmic contact layer 423 may be made of material including n+ amorphous silicon. The semiconductor layer, including the activation layer 421 and the ohmic contact layer 423, is formed adjacent to the gate electrode 411 of the switching device TFT.

A metal layer is formed over the first base substrate 401 having the semiconductor layer formed thereon. The metal layer is patterned to form a data metal pattern including a source electrode 431, a drain electrode 432 of the switching device TFT, and data lines 433 and 434 (DL in FIG. 5).

A passivation layer 403 is formed over the first base substrate 401 having the data metal pattern formed thereon. The passivation layer 403 has a thickness substantially equal to or less than about 4000 angstroms. The passivation layer 403 includes a contact hole H that exposes a portion of the drain electrode 432. The passivation layer 403 may be made of any suitable inorganic material. Alternatively, the passivation layer 403 may be made of material including an organic material or both an organic and inorganic material.

An optically transparent and electrically conductive layer may be made of materials including, but not limited to, indium tin oxide (ITO), indium zinc oxide (IZO), etc. The optically transparent and electrically conductive layer is formed over the first base substrate 401 having the passivation layer 403 formed thereon. The optically transparent and electrically conductive layer may be patterned to form a pixel electrode pattern.

The pixel electrode pattern includes the pixel electrode 441 (PE in FIG. 1) that is electrically connected to the drain electrode 432 of the switching device TFT through the contact hole H, and shielding common electrodes 442 and 443 (SCOM in FIG. 5). The shielding common electrodes 442 and 443 are disposed over the data lines 433 and 434 to cover the data lines 433 and 434 (hereinafter referred to as a “shielding corn structure”). The “shielding corn structure” prevents electrical interference between the pixel electrode 441 and the data lines 433 and 434 to enhance display quality.

A first alignment layer 450 is formed over the first base substrate 401 having the pixel electrode pattern formed thereon. The first alignment layer 450 has a first rubbing direction ‘R’ and a pre-tilt angle is in a range of about 2 degrees to about 5 degrees. The pre-tilt angle that is in a range of about 2 degrees to about 5 degrees corresponds to that of the TN mode LCD panel as described above.

The color filter substrate 500 includes a second base substrate 501, a light blocking pattern 510, a color filter pattern 520, a common electrode layer 530 and a second alignment layer 540. The second base substrate 501 may be made of any suitable optically transparent material. The light blocking pattern 510 is formed on the second base substrate 501 and includes a plurality of openings that may be arranged in a matrix shape. The color filter pattern 510 includes a red color filter, a green color filter and a blue color filter. Each of the red, green and blue color filters are disposed on the portions of second base substrate 501 exposed through the openings of the light blocking pattern 510.

The common electrode layer 530 is formed on the second base substrate 501 having the light blocking pattern 510 and the color filter pattern 520 formed thereon. The color filter substrate 500 may include a leveling layer that is disposed between the common electrode layer 530, and the light blocking and color filter patterns 510 and 520. In an exemplary embodiment, the leveling layer levels a surface of the light blocking and color filter patterns 510 and 520.

The second alignment layer 540 is formed on the common electrode layer 530. The second alignment layer 540 has the rubbing direction ‘R’ and a pre-tilt angle is in a range of about 2 degrees to about 5 degrees. In other words, the first and second alignment layers 450 and 540 may have the same rubbing direction, and the pre-tilt angles of the first and second alignment layers 450 and 540 are approximately the same.

Liquid crystal molecules of the liquid crystal layer 300 are arranged such that the LCD panel operates in the OCB mode. Furthermore, as described in FIG. 4, the liquid crystal layer 300 has a relatively low dielectric anisotropy Δε, which enhances manufacturing efficiency and lowers a manufacturing cost.

In an exemplary embodiment the liquid crystal apparatus including the “shielding corn structure” also includes the impulse driving method in order to stabilize a bend alignment of the liquid crystal layer 300.

FIG. 7 is a block diagram illustrating an exemplary embodiment of a display apparatus according to the present invention.

Referring to FIG. 7, a display apparatus includes a timing control section 610, a storing section 620, a driving voltage generating section 630, a data driving section 640, a gate driving section 650 and a display panel 660 that operates in the OCB mode.

The timing control section 610 generates a first control signal 610a, a second control signal 610b and a third control signal 610c, responsive to a control signal CONTL. The first, second and third control signals 610a, 610b and 610c correspond to a first driving frequency and the control signal CONTL corresponds to a second driving frequency. The first drive frequency and the second drive frequency may have the same frequency or operate at distinct frequencies.

The first control signal 610a is presented to the driving voltage generating section 630. The second control signal 610b is presented to the data driving section 640. The third control signal 610c is presented to the gate driving section 650.

The timing control section 610 receives a primitive data signal DATA and transfers the primitive data signal DATA to the data driving section 640 via the primitive data signal 610d.

The timing control section 610 presents the primitive data signal DATA having a first driving frequency to the storing section 620. The storing section 620 stores the primitive data signal DATA by a frame unit. The timing control section 610 reads the primitive data signal DATA from the storing section 620 synchronized with a second driving frequency. The storing section 620 may store a black data of one frame for impulsive driving.

In an exemplary embodiment, the second driving frequency is m-times larger than the first driving frequency. For example, when the first driving frequency is 60 Hz and the second driving frequency is 120 Hz, during one frame corresponding to the first driving frequency, an n-th primitive data is applied to the data driving section during a first half frame, and the gray scale voltage corresponding to black is applied to the data driving section during a second half frame.

The driving voltage generating section 630 generates driving voltages. The voltage generating section 630 presents gate voltages 630a to the gate driving section 650, reference voltages 630b to the display panel 660, and reference gray scale voltage 630c to the data driving section 640. The reference voltages 630b include reference voltages applied to the storage wiring and the common electrode of the color filter substrate and a second reference voltage applied to the shielding common electrode when the display apparatus includes the “shielding corn structure”.

In an exemplary embodiment, the data driving section 640 converts the primitive data signal 610d that corresponds to a digital signal into data that corresponds to an analog signal, and applies the data to the display panel 660.

In an exemplary embodiment, the second driving frequency is 120 Hz and the n-th frame primitive data corresponding to a digital signal is converted into a data corresponding to an analog signal. The data driving section 640 applies the data to the display panel 660 during the first half frame, and a gray scale corresponding to a black color is applied to the display panel 660 during the second half frame. Data that is stored in the storing section 620 may be used as the gray scale corresponding to the black color. Alternatively, the data driving section 640 may generate the gray scale corresponding to the black color. The gray scale corresponding to the black color corresponds to a higher voltage than that of a normal image data.

The gate driving section 650 generates gate signals based on the third control signal 630c provided from the timing control section 630 and the gate voltages 630a provided from the driving voltage generating section 630. The gate signals generated from the gate driving section 650 are applied to the display panel 660.

The display panel 660 includes an array substrate, a color filter substrate and a liquid crystal layer disposed between the array substrate and the color filter substrate. The liquid crystal layer may be operated in the OCB mode. The display panel 660 includes either the “partial corn structure” or the “shielding corn structure”, so that the interference between the data line and the pixel electrode is prevented. Additionally, the display panel 660 may include the alignment layer that aligns liquid crystal molecules to have a relatively low pre-tilt angle, and liquid crystal molecules that have a relatively low dielectric anisotropy.

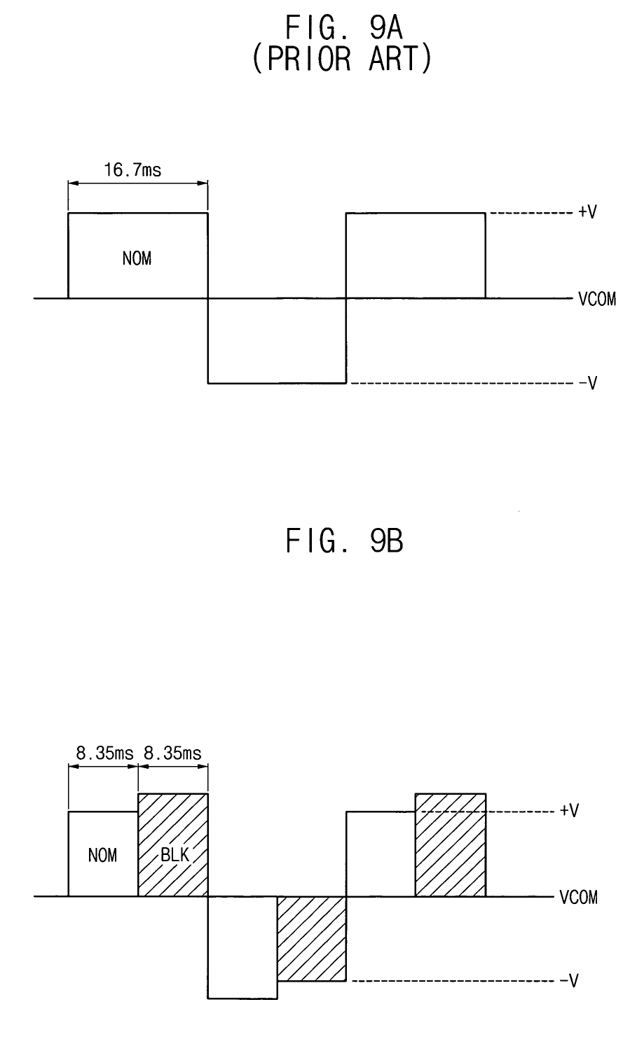

FIG. 8 is a block diagram illustrating a timing control section in FIG. 7.

Referring to FIG. 8, the timing control section 610 includes a control part 611 and a control signal generating part 613. The control part 611 applies the primitive data signal DATA to the storing section 620 or reads the primitive data signal DATA from the storing section 620. The control part 611 also controls the control signal generating part 613. The control part 611 presents the primitive data signal DATA stored in the storing section 620 to the data driving section 640 synchronized with the second driving frequency.

Additionally, the control part 611 controls the control signal generating part 613. Specifically, the control part 611 controls the control signal generating part 613, to generate the second driving frequency based on the first driving frequency. The control signal generating part 613 generates the first, second and third control signals 610a, 610b and 610c corresponding to the second driving frequency, responsive to the control signal CONTL corresponding to the first driving frequency.

The first control signal 610a is presented to the driving voltage generating section 630. The second control signal 610b is presented to the data driving section 640. The third control signal 610c is presented to the gate driving section 650.

In an exemplary embodiment, the control signal CONTL includes a main clock signal MCLK, a horizontal synchronization signal HSYNC, a vertical synchronization signal VSYNC and a data enable signal DE. The first control signal 610a includes the main clock signal MCLK. The second control signal 610b includes a horizontal start signal STH and a load signal TP. The third control signal 610c includes a start signal STV, a scan clock signal CPV and an output enable signal OE.

When a ratio of a normal frame corresponding to an image, to a black frame corresponding to a gray scale of a black color is one to one (16.2 ms/2 to 16.2 ms/2), and the control signal generating part 613 generates the first, second and third control signals 610a, 610b and 610c based on the second driving frequency of 120 Hz.

When a ratio of a normal frame corresponding to an image, to a black frame corresponding to a gray scale of a black color is four to one (16.7 ms×⅘ to 16.6 ms×⅕), the second driving frequency corresponds to 75 Hz during displaying of the normal frame, and corresponds to 300 Hz during displaying of the black frame. The control signal generating part 613 generates the first, second and third control signals 610a, 610b and 610c, based on the second driving frequency of 75 Hz during the 4/5 frame, and generates the first, second and third control signals 610a, 610b and 610c, based on the second driving frequency of 300 Hz during the 1/5 frame.

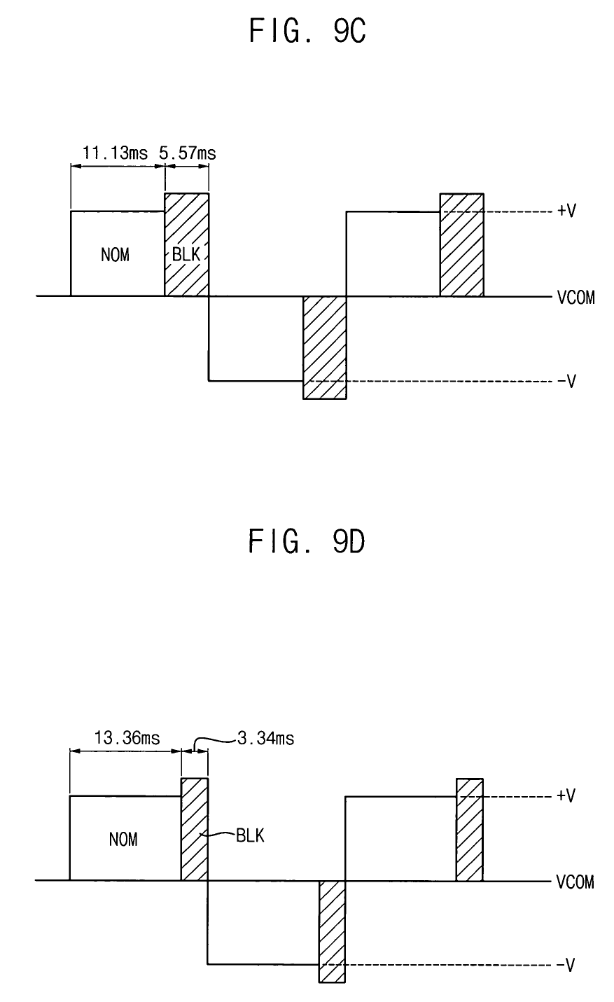

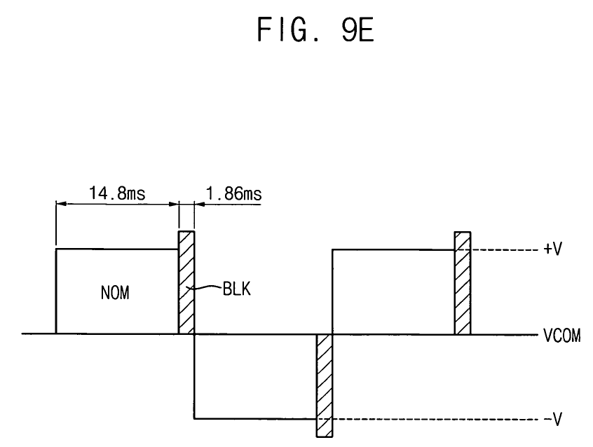

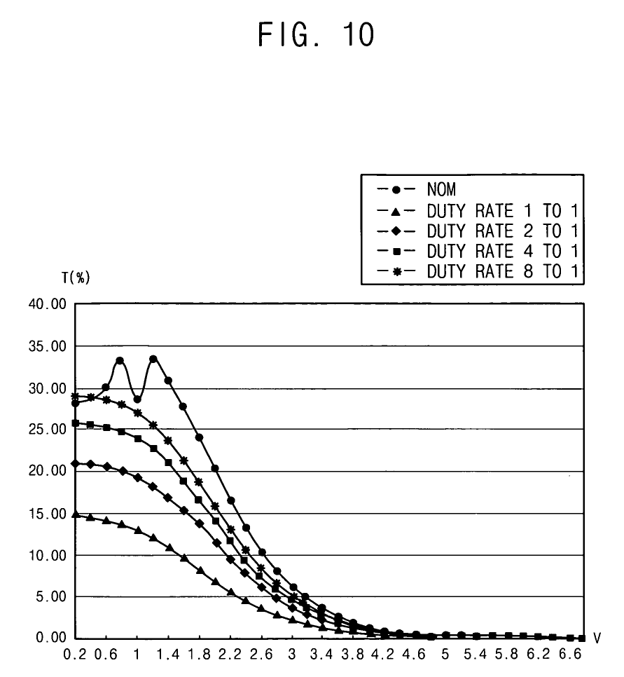

FIG. 9A is a timing diagram illustrating a conventional driving method. FIGS. 9B to 9E are timing diagrams illustrating various impulsive driving methods according to exemplary embodiments of the present invention, and FIG. 10 is a graph displaying VT curves corresponding to each impulse driving method in FIGS. 9A to 9E.

Referring to FIG. 9A, during one frame of about 16.7 ms, a gray scale voltage NOM corresponding to an n-th frame data is outputted. Referring to FIG. 10, a gray scale voltage corresponding to a white color is in a range of about 1.8V, which corresponds to the critical voltage Vc, to about 2V, which corresponds to a minimum voltage for maintaining a bend alignment state of liquid crystal molecules, and a gray scale voltage corresponding to a black color is about 6V, which corresponds to a maximum voltage. In order for the LCD apparatus to stably operate in the OCB mode, the gray scale voltage corresponding to a white color has to be substantially larger than the critical voltage Vc.

FIG. 9B is a timing diagram illustrating the impulsive driving method according to a first exemplary embodiment of the present invention.

Referring to FIG. 9B, a gray scale voltage NOM corresponding to an image is outputted during a first half period (16.7/2 ms≈8.35 ms), and a gray scale voltage BLK corresponding to a black color is outputted during a second half period (16.7/2 ms≈8.35 ms) in order to enhance a visibility of the image. Referring to FIG. 10, the VT curve of duty ratio 1 to 1 shows that even when the gray scale voltage corresponding to a white color becomes 0V, the bend alignment state is not broken.

FIG. 9C is a timing diagram illustrating the impulsive driving method according to a second exemplary embodiment of the present invention.

Referring to FIG. 9C, a gray scale voltage NOM corresponding to an image is outputted during a first two-thirds period (16.7×⅔ ms≈11.13 ms), and a gray scale voltage BLK corresponding to a black color is outputted during a second one-third period (16.7×⅓ ms≈5.57 ms) in order to enhance a visibility of the image.

Referring to FIG. 10, the VT curve of duty ratio 2 to 1 shows that even when the gray scale voltage corresponding to a white color becomes 0V, the bend alignment state is not broken. Furthermore, a luminance is enhanced with respect to the case of duty ratio 1 to 1.

FIG. 9D is a timing diagram illustrating the impulsive driving method according to a third exemplary embodiment of the present invention.

Referring to FIG. 9D, a gray scale voltage NOM corresponding to an image is outputted during a first four-fifths period (16.7×⅘ ms≈13.36 ms), and a gray scale voltage BLK corresponding to a black color is outputted during a second one fifth period (16.7×⅕ ms≈3.34 ms) in order to enhance a visibility of the image.

Referring to FIG. 10, the VT curve of duty ratio 4 to 1 shows that even when the gray scale voltage corresponding to a white color becomes 0V, the bend alignment state is not broken. Furthermore, a luminance is enhanced with respect to the case of duty ratio 1 to 1.

FIG. 9E is a timing diagram illustrating the impulsive driving method according to a third exemplary embodiment of the present invention.

Referring to FIG. 9E, a gray scale voltage NOM corresponding to an image is outputted during a first eight-ninths period (16.7× 8/9 ms≈14.8 ms), and a gray scale voltage BLK corresponding to a black color is outputted during a second one-ninth period (16.7× 1/9 ms≈1.86 ms) in order to enhance a visibility of the image. Referring to FIG. 10, the VT curve of duty ratio 8 to 1 shows that even when the gray scale voltage corresponding to a white color becomes 0V, the bend alignment state is not broken. Furthermore, a luminance is enhanced with respect to the case of duty ratio 1 to 1.

Hereinbefore, the gray scale data NOM corresponding to an image is firstly displayed, and then the gray scale data BLK corresponding to a black color is secondly displayed. Alternatively, the gray scale data BLK corresponding to a black color may be firstly displayed, and then the gray scale data NOM corresponding to an image may be secondly displayed. However, in both cases, the time period for the gray scale data NOM is longer than the time period for the gray scale data BLK.

According to the an exemplary embodiment of the present invention, the display apparatus is driven by the impulsive driving method described above, so that even when the gray scale voltage corresponding to a white color is lowered to be about 0V, the bend alignment state of liquid crystal molecules is stably maintained.

Furthermore, the display apparatus according to an exemplary embodiment of the present invention may employ the “partial corn structure” as shown in FIG. 1 or the “shielding corn structure” as shown in FIG. 5, so that interference between the data line and the pixel electrode is prevented to enhance a display quality.

Additionally, as shown in FIGS. 1 to 5, the display apparatus according to exemplary embodiments of the present invention employs a relatively low pre-tilt angle, and liquid crystal having relatively low dielectric anisotropy. Therefore, a manufacturing efficiency is enhanced to lower a manufacturing cost.

As described above, according to an exemplary embodiment of the present invention, electric interference between the data line and the pixel electrode is reduced, the bend alignment state is stably maintained, and the manufacturing costs is lowered.

Having described the exemplary embodiments of the present invention and its advantages, it is noted that various changes, substitutions and alterations can be made herein without departing from the spirit and scope of the invention as defined by appended claims.

What is claimed is:

1. A display panel comprising:
a first substrate;
a second substrate that faces the first substrate and includes a switching device that is electrically connected to a data line and a gate line, a pixel electrode that is electrically connected to the switching device, and an interference-reducing member that reduces electrical interference between the data line and the pixel electrode; and
a liquid crystal layer disposed between the first and second substrates, the liquid crystal layer being operated in an optical compensated bend (OCB) mode.

2. The display panel of claim 1, wherein the interference-reducing member corresponds to a storage common wiring, a portion of the storage common wiring being covered by the pixel electrode.

3. The display panel of claim 2, wherein the storage common wiring is substantially in parallel with the data line.

4. The display panel of claim 1, wherein the interference-reducing member includes a shielding common electrode that covers the data line.

5. The display panel of claim 4, wherein the shielding common electrode and the common electrode are formed from a same layer.

6. The display panel of claim 1, wherein the first substrate comprises a first alignment layer having a pre-tilt angle of about 2 degrees to about 5 degrees.

7. The display panel of claim 1, wherein the second substrate further comprises a second alignment layer having a pre-tilt angle of about 2 degrees to about 5 degrees.

8. The display panel of claim 6, wherein the second substrate further comprises a second alignment layer having a pre-tilt angle of about 2 degrees to about 5 degrees.

9. The display panel of claim 1, wherein the liquid crystal layer has a dielectric anisotropy in a range of about 5 to about 10.

10. A display apparatus comprising:
a display panel including:
a first substrate;
a second substrate that faces the first substrate and includes an interference-reducing member; and
a liquid crystal layer disposed between the first and second substrates, the liquid crystal layer being operated in an optical compensated bend (OCB) mode; and
a driving part that applies a gray scale voltage corresponding to an image during a first period of a frame and a gray scale voltage corresponding to a non-image during a second period of the frame to the display panel.

11. The display apparatus of claim 10, wherein the interference-reducing member reduces a electrical interference between a data line and a pixel electrode.

12. The display apparatus of claim 10, wherein the gray scale voltage corresponding to the non-image is higher than the gray scale voltage corresponding to the image.

13. The display apparatus of claim 10, wherein the gray scale voltage corresponding to the non-image is a gray scale voltage corresponding to a black color.

14. The display apparatus of claim 10, wherein the first period is prior to the second period.

15. The display apparatus of claim 10, wherein the second period is prior to the first period.

16. The display apparatus of claim 10, wherein the first period is substantially equal to or longer than the second period.

17. The display apparatus of claim 10, wherein the second period is in a range of about 1/11 of the frame to about ½ of the frame.

18. The display apparatus of claim 11, wherein the interference-reducing member corresponds to a storage common wiring, a portion of the storage common wiring being covered by the pixel electrode.

19. The display apparatus of claim 11, wherein the interference-reducing member corresponds to a shielding common electrode that covers the data line.

20. The display apparatus of claim 10, wherein the display panel comprises a first alignment layer facing a first side of the liquid crystal layer, and a second alignment layer facing a second side of the liquid crystal layer, and the first and second alignment layer have a pre-tilt angle in a range of about 2 degrees to about 5 degrees.

21. The display apparatus of claim 10, wherein the liquid crystal layer has a dielectric anisotropy in a range of about 5 to about 10.

22. A display apparatus comprising:
a display panel including a liquid crystal layer having a dielectric anisotropy in a range of about 5 to about 10, a first alignment layer facing a first side of the liquid crystal layer, a second alignment layer facing a second side of the liquid crystal layer, and an interference-reducing member that reduces an electric interference between a data line and a pixel electrode; and
a driving part that applies a gray scale voltage corresponding to an image during a first period of a frame, and a gray scale voltage corresponding to a non-image during a second period of the frame to the display panel.
